(19) United States
(12) Patent Application Publication
(10) Pub. No.: US 2013/0029015 A1
(43) Pub. Date: Jan. 31, 2013

(54) FOOD COMPOSITION OF VEGETABLES FOR DEVELOPING NATURAL FOODS SUCH AS: SAUSAGES, HAMBURGERS

(71) Applicant: Alberto Susbielles Repetto, Santiago (CL)

(72) Inventor: Alberto Susbielles Repetto, Santiago (CL)

(21) Appl. No.: 13/575,239

(22) PCT Filed: Feb. 24, 2011
(86) PCT No.: PCT/IB11/50790

§ 371 Date: Oct. 15, 2012

(30) Foreign Application Priority Data
Apr. 12, 2010 (CL) 354-2010

(51) Int. Cl. A23L 1/305; A23P 1/08; A23J 3/16; A23L 1/20; A23L 1/03

(52) U.S. Cl. 426/138; 426/656; 426/541; 426/542; 426/546; 426/519; 426/284; 426/545; 426/512; 426/106; 426/413

(57) ABSTRACT

Food composition for making sausages or hamburgers comprising a vegetable, selected from among Swiss chard, spinach, mushroom, sweetcom or another, a proteinaceous material, salt and water and, optionally, antioxidants and flavourings, both thereof in particular of natural origin. The proteinaceous material used comprises a combination of proteins isolated from soya and proteins isolated from whey. The method of preparation of the composition comprises mixing the proteinaceous material with water, adding ice in flakes and forming an emulsion, to which are added the vegetable and the salt and, in an optional manner, antioxidants and/or flavourings.

There is currently an increasing need for consumption of healthy food containing low fat levels and also low in calories. On the other hand, for many consumers, children, adults and elders alike, healthy low-fat, low-calories food such as salads and vegetables are hardly appetizing. Among these consumers, children are a very relevant group, in which obesity indexes have increased as a byproduct of sedentary lifestyle and saturated fat-overloaded food. To face this panorama, the necessity arises of providing food products that are both healthy and tasty for consumers that do not like traditional healthy food or for those who, even when liking healthy food, are in search of original and tasty alternatives. The present invention comes to solve this technical problem, offering a very healthy food composition rich in protein, fiber and antioxidants and at the same time low in fat and calories, with no oils, which can be formulated in a number of ways, among which vegetal sausages and hamburgers stand out. The invention also provides a method to manufacture said composition.

### BRIEF DESCRIPTION OF THE DRAWINGS

FIG. 1 is a picture illustrating spinach sausages and hamburgers manufactured with the composition according to the invention.

FIG. 2 is a picture illustrating different sausages manufactured with the composition of the invention, in which the vegetables used were Swiss chard, sweet corn, spinach and mushrooms.

### DETAILED DESCRIPTION OF THE INVENTION

The composition of the invention comprises a vegetable, selected e.g. from the group consisting in Swiss chard, spinach, mushroom and sweet corn, a proteinaceous material, salt and water, optionally comprising antioxidants and flavorings, especially when both are from natural sources. The proteinaceous material used in the composition comprises a blend of proteins isolated from soybean, such as e.g. Supro 500 E ® and proteins isolated from whey.

The manufacturing method of the invention comprises: mixing the isolated proteinaceous material with water to obtain a homogeneous mixture, subsequently adding ice flakes to said mixture and mixing continuously to form an emulsion. The vegetal material is added into this emulsion and mixed until homogenizing the entire composition, and subsequently adding salt and optionally antioxidants and/or flavorings, and mixing to obtain a homogeneous food composition. The obtained composition is used to form sausages, hamburgers or other products (such as pâté, Wiener schnitzels or escalopes, sauces, etc.) in traditional ways, then sausages or hamburgers are finally cooked and the cooking process is stopped by sudden cooling.

Salt used in the products of the invention is substantially pure non-iodinated salt, and therefore the products could be consumed by heart-ill people. Moreover, since the products of the invention do not contain meat but vegetables and isolated proteins, they do not contain saturated oils or fat, and therefore they are safe for people with high cholesterol levels and all those who wish to look after their health. Since they contain vegetables and whey and soy proteins, the products are also appropriate for vegetarians that consume milk and its derivatives.

The food composition of the invention comprises a high percentage of vegetables, which are naturally incorporated into it without dehydration processes (i.e. fresh vegetables). These vegetables are selected from: Swiss chard, sweet corn (corn), mushroom, avocado, artichoke, celery, turnip, sweet potato, eggplant (aubergine), broccoli, cauliflower, endive, asparagus, sweet pea, broad bean, lettuce, potato, cucumber, leek, radish, beet (beetroot), cabbage, tomato, carrot, truffle, parsley, chives, pumpkin (squash), onion, sweet pepper, French bean, hot pepper, watercress, lentil, broad lentil (lentejon), beans, chickpea, rice, peanut, nuts, apple, plum, grape, melon, watermelon, orange, banana or plantain, kiwi fruit, strawberry, peach, pineapple, cherry, mandarin or tangerine, grapefruit, blueberry, quince, lemon or a combination of the same. Preferably, the used vegetables are Swiss chard, spinach, sweet corn or mushroom. These vegetables are responsible of the flavor and the desired texture of the product.

The products of the invention, i.e. hamburgers or sausages, have the same texture than traditional hamburgers or sausages, the same sponginess than sausages or hamburgers made from beef meat, pork meat, chicken or turkey meat or any other red or white meat-containing hamburger or sausage. This characteristic will make the products very desirable for consumers of traditional products, especially children, being as such a healthy and at the same time tasty alternative.

There are in the market other vegetal hamburgers and sausages as well as home-made recipes to prepare both products. The main difference between those products and the composition of the invention is the nature of the proteinaceous material used. The majority of the current products use whole or fractionated soy as proteinaceous material, and there are also products that use albumin (from egg white) and those comprising different plant components with no added proteinaceous fraction. For example, the Patent CA2377125 (2002-09-29) protects a vegetal sausage analog comprising edible vegetal protein, and the texture is given by a carbohydrate gel. Instead, the composition of this invention comprises a proteinaceous material comprising a blend of proteins isolated from soy, such as Supro 500 E ®, and proteins isolated from whey. Another advantage of the invention is that it uses isolated proteins that do not comprise additional components such as fat and the like, and furthermore both proteins are highly digestible. There is no other commercially available vegetal sausage or hamburger composition comprising a combination of both proteins.

In a preferred implementation, the composition of the invention comprises:
1 5 to 20% of a blend of isolated proteins, wherein said blend comprises 5 to 20% of whey protein and 80 to 95% of isolated soy protein apt for human consumption;
70 to 90% of water,
2 to 10% of a vegetable selected from Swiss chard, sweet corn (corn), mushroom, avocado, artichoke, celery, turnip, sweet potato, eggplant (aubergine), broccoli, cauliflower, endive, asparagus, sweet pea, broad bean, lettuce, potato, cucumber, leek, radish, beet (beetroot), cabbage, tomato, carrot, truffle, parsley, chives, pumpkin (squash), onion, sweet pepper, French bean, hot pepper, watercress, lentil, broad lentil (lentejon), beans, chickpea, rice, peanut, nuts, apple, plum, grape, melon, watermelon, orange, banana or plantain, kiwi fruit, strawberry, peach, pineapple, cherry, mandarin or tangerine, grapefruit, blueberry, quince, lemon or a combination of the same, the vegetable being washed, disinfected and cooked according to each particular case,
1 to 4% of salt, such as substantially pure NaCl,
0 to 4% of antioxidants, particularly from natural sources, and most particularly dehydrated lemon,
0 to 4% of flavorings, particularly from natural sources, and most particularly dehydrated versions of the same vegetables incorporated into the product, which can be creams, liquids or powders.

Particularly, the preferred vegetables are Swiss chard, spinach, sweet corn (corn), mushroom and avocado.

Besides dehydrated lemon, any other commercially available antioxidant of the art can be used, such as concentrated lemon juice, citric acid, ascorbic acid (vitamin C), tocopherol (vitamin E), carotene, TBHQ, BHA or BHT. Particularly, natural antioxidants are preferred.

The manufacturing method of the invention comprises the following steps, wherein percentages are expressed as a function of the total weight of the product:
mixing 5 to 20% of a blend of isolated proteins, wherein said blend comprises 5 to 20% of whey protein and 80 to 95% of isolated soy protein apt for human consumption, with 35 to 45% of water to obtain a homogeneous mixture;
slowly adding 35 to 45% of ice flakes and mixing to form an emulsion;
adding 2 to 10% of vegetal material and mixing to homogenize the mixture;
adding 1 to 4% of salt, 0 to 4% of antioxidants and/or 0 to 4% of flavorings and mixing to homogenize the mixture.

Optionally:
forming sausages or hamburgers with the mixture obtained using traditional modes,
cooking the sausages or hamburgers at a temperature between 60 and 90° C. for 30 to 90 minutes, depending on the diameter of the sausage or hamburger, or until it is cooked at its center, and
stopping the cooking with sudden cooling, exposing sausages or hamburgers to a temperature of 10° C. or less for 30 seconds to 5 minutes, preferably for 2 minutes.

The traditional methods for sausage and hamburger manufacture are well known by someone skilled in the art, and comprise stuffing plastic or collagen sleeves with the food composition, having a diameter of 17, 19, 20 or 22 millimeters for sausages and 8 to 10 centimeters in the case of hamburgers.

### EXAMPLE OF AN EMBODIMENT

For manufacturing 10 kg of product, 1 kg of isolated soy protein Supro 500 E ® apt for human consumption was used. This amount of Supro 500 E ® protein was mixed with 300 grams of whey protein and 4 liters of water to obtain a homogeneous mixture, and once homogeneity was attained 4 kg of ice flakes were added to form an emulsion.

To this emulsion, the vegetal material was added, in this case 600 g of boiled and minced Swiss chard. The mixture was homogenized until a uniform mass was obtained with the green color of Swiss chard. To this mass, 200 g of pure NaCl and 200 g of dehydrated lemon were added, this last acting as a natural antioxidant. In this way, the composition of the invention was obtained.

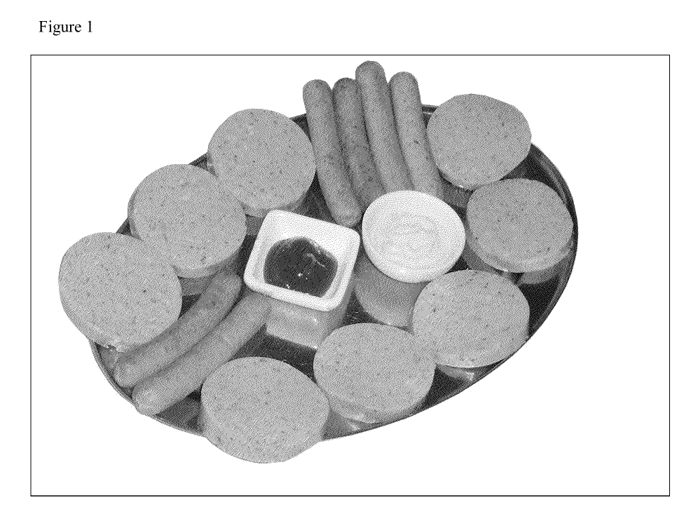

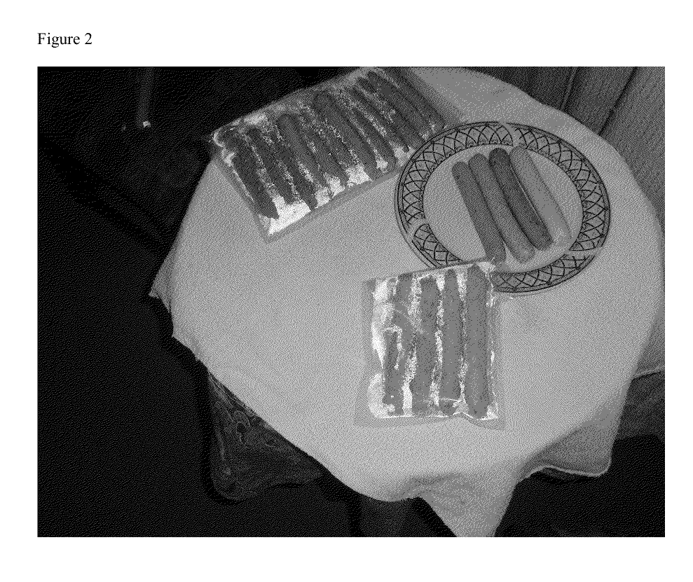

Collagen sleeves were stuffed with this composition to make 17 mm-diameter sausages, and other part was used to stuff a polyethylene sleeve to make 10 cm-diameter hamburgers. Both products were boiled at 60 and 64° C. for 30 and 90 minutes, respectively, and then the cooking was stopped by immersing the products in cold water, after which the products were ready for consumption. FIG. 1 shows a picture of the products manufactured in this example, which have excellent appearance and texture, as can be observed. FIG. 2 shows a picture of sausages of the invention, made with Swiss chard, sweet corn, spinach and mushrooms, respectively.

1. A food composition comprising:
5 to 20% of a blend of isolated proteins, wherein said blend comprises 5 to 20% of whey protein and 80 to 95% of isolated soy protein apt for human consumption,
70 to 90% of water,
2 to 10% of a vegetable selected from Swiss chard, sweet corn (corn), mushroom, avocado, artichoke, celery, turnip, sweet potato, eggplant (aubergine), broccoli, cauliflower, endive, asparagus, sweet pea, broad bean, lettuce, potato, cucumber, leek, radish, beet (beetroot), cabbage, tomato, carrot, truffle, parsley, chives, pumpkin (squash), onion, sweet pepper, French bean, hot pepper, watercress, lentil, broad lentil (lentejon), beans, chickpea, rice, peanut, nuts, apple, plum, grape, melon, watermelon, orange, banana or plantain, kiwi fruit, strawberry, peach, pineapple, cherry, mandarin or tangerine, grapefruit, blueberry, quince, lemon or a combination of the same, the vegetable being washed, disinfected and cooked according to each particular case,
1 to 4% of salt, such as substantially pure NaCl,
0 to 4% of antioxidants, and
0 to 4% of flavorings.

2. A food composition according to claim 1 wherein the antioxidants are selected from the group consisting of dehydrated lemon or concentrated lemon juice, citric acid, ascorbic acid (vitamin C), tocopherol (vitamin E), carotene, T.B.H.Q., B.H.A. or B.H.T.

3. A food composition according to claim 2 wherein the antioxidant is dehydrated lemon or concentrated lemon juice.

4. A food composition according to claim 1 wherein the flavorings have natural origin.

5. A food composition according to claim 4 wherein the flavorings are dehydrated versions of the same vegetables incorporated into the product.

6. A process to manufacture the composition of claim 1 wherein said process comprises the steps of:
mixing 5 to 20% of a blend of isolated proteins, wherein said blend comprises 5 to 20% of whey protein and 80 to 95% of isolated soy protein apt for human consumption, with 35 to 45% of water to obtain a homogeneous mixture;
slowly adding 35 to 45% of ice flakes and mixing to form an emulsion;
adding 2 to 10% of vegetal material and mixing to homogenize the mixture; and
adding 1 to 4% of salt, 0 to 4% of antioxidants and/or 0 to 4% of flavorings and mixing to homogenize the mixture.

7. A process according to claim 6 wherein said process further comprises the steps of:
forming sausages or hamburgers with the mixture obtained using traditional modes,
cooking the sausages or hamburgers at a temperature between 60 and 90° C. for 30 to 90 minutes, depending on the diameter of the sausage or hamburger, or until it is cooked at its center, and
stopping the cooking with sudden cooling.

8. A process according to claim 7 wherein sausages are formed by stuffing 17, 19, 20 or 22 mm-diameter plastic or collagen sleeves with the composition.

9. A process according to claim 7 wherein hamburgers are formed by stuffing 8 or 10 cm-diameter plastic or collagen sleeves with the composition.

10. A food product in the form of a vegetal sausage wherein said product comprises the composition of claim 1 stuffed into a 17, 19, 20 or 22 mm-diameter plastic or collagen sleeve.

11. A food product in the form of a vegetal hamburger wherein said product comprises the composition of claim 1 stuffed into an 8 or 10 cm-diameter plastic or collagen sleeve.
